(19) United States
(12) Patent Application Publication
(10) Pub. No.: US 2017/0192734 A1
(43) Pub. Date: Jul. 6, 2017

(54) MULTI-INTERFACE UNIFIED DISPLAYING SYSTEM AND METHOD BASED ON VIRTUAL REALITY

(71) Applicants: LE HOLDINGS (BEIJING) CO., LTD., BEIJING (CN); LE SHI ZHI XIN ELECTRONIC TECHNOLOGY (TIANJIN) LIMITED, TIANJIN (CN)

(72) Inventor: Lin NIE, Tianjin (CN)

(21) Appl. No.: 15/242,204

(22) Filed: Aug. 19, 2016

Related U.S. Application Data
(63) Continuation of application No. PCT/CN2016/089237, filed on Jul. 7, 2016.

(30) Foreign Application Priority Data
Dec. 31, 2015 (CN) 201511034715.X

(51) Int. Cl. G06F 3/14; G06F 3/0346; G09G 5/00; G06F 3/01; G06T 19/00; G06T 5/00

(52) U.S. Cl. CPC G06F 3/1454; G06T 19/006; G06T 5/006; G09G 5/005; G06F 3/012; G06F 3/0346; G09G 2360/18; G06T 2210/32; G09G 2370/022; G09G 2370/20; H04L 67/28

(57) ABSTRACT

The present disclosure discloses a multi-interface unified displaying system and method based on virtual reality. The system includes: a plurality of remote desktop proxy servers, respectively built in a corresponding plurality of intelligent electronic devices to obtain current screen images of the intelligent electronic devices; and a virtual reality machine. The virtual reality machine further includes a plurality of remote desktop proxy clients correspondingly connected to the remote desktop proxy servers to obtain the corresponding current screen images of the intelligent electronic devices; a virtual reality 3D engine, configured to convert the current screen images on the intelligent electronic devices into a map that is identifiable by a graphics programming interface, then bind the map to a surface of a corresponding window in a virtual scene, further respectively render images corresponding to a left eye and a right eye into a pair of established buffer area, and perform an anti-distortion processing to contents in the buffer areas.

### CROSS REFERENCE TO RELATED APPLICATION

The present application is the continuous application of the PCT application PCT/CN2016/089237, filed on Jul. 7, 2016. The present disclosure claims priority of Chinese Patent Application 201511034715X, titled “MULTI-INTERFACE UNIFIED DISPLAYING SYSTEM AND METHOD BASED ON VIRTUAL REALITY”, filed with the Chinese State Intellectual Property Office on Dec. 31, 2015, the entire contents of which are incorporated herein by reference.

### TECHNICAL FIELD

The present disclosure relates to the field of virtual reality technology, and in particular, to a multi-interface unified displaying system and method based on virtual reality.

### BACKGROUND

In daily work and life, people frequently use various intelligent electronic devices having user interfaces (UI), such as smart phone, computer and the like. During the usage, the people have to view the user interfaces of these intelligent products separately, which is cumbersome. During the development of the present invention, the inventor discovers that: it is very convenient for a user to operate these intelligent electronic devices if the user interfaces of multiple intelligent electronic devices are viewed simultaneously in one interface.

### SUMMARY

A technical problem to be solved by the embodiments of the present disclosure is to provide a multi-interface unified displaying system based on virtual reality, so as to simultaneously display user interfaces of a plurality of intelligent electronic devices.

Another technical problem to be solved by the embodiments of the present disclosure is to provide a multi-interface unified displaying method based on virtual reality, so as to simultaneously display user interfaces of a plurality of intelligent electronic devices.

To solve the above technical problems, the embodiments of the present disclosure provide technical solutions as follows: a multi-interface unified displaying system based on virtual reality, which includes:

a plurality of remote desktop proxy servers, respectively built in a corresponding plurality of intelligent electronic devices to obtain corresponding current screen images of the intelligent electronic devices and transmit the screen images to the outside; and

a virtual reality machine, which further includes:

a plurality of remote desktop proxy clients, correspondingly connected to the remote desktop proxy servers one by one to obtain the current screen images of the corresponding intelligent electronic devices;

a virtual reality 3D engine, configured to convert the current screen images of the intelligent electronic devices transmitted from different remote desktop proxy clients into a map that is identifiable by a graphics programming interface, then bind the map to a surface of a corresponding window in a virtual scene, further respectively render images corresponding to a left eye and a right eye into a pair of established buffer areas via the graphics programming interface, and perform an anti-distortion processing with respect to contents in the buffer areas; and

a displaying service module, configured to display the images processed in the buffer areas.

Further, the intelligent electronic device is at least one of a personal computer and a smart phone.

Further, the virtual reality machine is a virtual reality helmet.

In another aspect, the embodiments of the present disclosure further provide a multi-interface unified displaying method based on virtual reality, which includes the following steps:

step S1: intercepting current screen images by remote desktop proxy servers, and transmitting the current screen images to remote desktop proxy clients of a VR machine via network;

step S2: receiving the current screen images of intelligent electronic devices by the remote desktop proxy clients of the VR machine, and transmitting the current screen images to a VR 3D engine;

step S3: converting, by the 3D engine, the current screen images of the intelligent electronic devices transmitted from different proxy clients into a map format that is identifiable by a graphics programming interface;

step S4: binding the map to a surface of a corresponding window in a virtual scene by the 3D engine, and respectively rendering images corresponding to a left eye and a right eye into a pair of established buffer areas via the graphics programming interface;

step S5: performing, by the 3D engine, an anti-distortion processing to contents in the buffer areas, in order to coordinate an image distortion caused by optical lens of a helmet; and

step S6: submitting the images processed in the buffer areas to a displaying service module for displaying.

Further, the graphics programming interface is OpenGL.

Further, the method further includes the following step:

step S7: performing a displacement control on a mouse pointer in displayed images by the simulation of the virtual reality machine.

Further, the step S7 specifically includes:

step S71: obtaining, by a gyroscope of the virtual reality machine, rotation angular velocities of user head along x, y and z axis;

step S72: obtaining a corresponding rotation angle by calculation according to a current rotation angular velocity and a time interval between current time and a time of previous sampling;

step S73: fixing the mouse pointer to a center of a screen coordinate; reversely rotating, by the 3D engine, a current scene by the above angle, and recalculating coordinate of the mouse pointer; and

step S74: transmitting the new coordinate of the mouse pointer to the servers via the remote desktop proxy clients.

Further, in the step S72, a data fusion algorithm is adopted for calculating to obtain the corresponding rotation angle.

Further, in the step S6, the images processed in the buffer areas are submitted to the displaying service module via an application programming interface of EGL.

The embodiments of the present disclosure further provide a nonvolatile computer storage media, which stores computer-executable instructions for executing the steps S2-S7 of the multi-interface unified displaying method based on virtual reality aforementioned.

The embodiments of the present disclosure further provide an electronic device, which includes: at least one processor; and a memory; wherein the memory stores instructions that are executable by the at least one processor, and the instructions are configured to execute steps S2-S7 of the multi-interface unified displaying method based on virtual reality aforementioned.

With the above technical solutions, the present disclosure has at least the following benefits. By simulating a function of 360×180 degree all-direction vision with a VR machine, corresponding current screen images of intelligent electronic devices are obtained by correspondingly connecting a plurality of remote desktop proxy clients to remote desktop proxy servers built in the corresponding intelligent electronic devices one by one, and the current screen images are intensively presented in a virtual reality scene after being processed by a 3D engine 32. Thus, a user may conveniently view user interfaces of a plurality of intelligent electronic devices simultaneously in a single interface such as the virtual reality scene, thereby more favorable to intensively and efficiently view and manage these user interfaces. Furthermore, a simple operation on intelligent electronic devices, for example, a displacement control on a mouse pointer, may be realized in combination with a control function of the virtual reality machine.

It should be understood that, the above general description and any detailed description illustrated hereinafter are merely exemplary and explanatory, which are not a limit to the present disclosure.

### BRIEF DESCRIPTION OF THE DRAWINGS

The figures for the embodiments or the prior art are briefly described as follows to illustrate the embodiments of the present disclosure or technical solutions in the prior art more clearly. Obviously, the figures described as below are merely some examples of the present disclosure, and one of ordinary skilled in the art can obtain other figures according to these figures without creative efforts.

FIG. 1 is a block diagram illustrating a system structure of a multi-interface unified displaying system based on virtual reality according to the present disclosure;

FIG. 2 is a schematic flowchart illustrating a multi-interface unified displaying method based on virtual reality according to the present disclosure;

FIG. 3 is a schematic flowchart illustrating a control on a mouse pointer realized by a multi-interface unified displaying method based on virtual reality according to the present disclosure.

FIG. 4 is a hardware structure diagram for the multi-interface unified displaying method based on virtual reality provided by the embodiments of the present disclosure.

### DETAILED DESCRIPTION

It should be noted that, in a non-conflict case, the embodiments of the present application and features in the embodiments may be combined with each other. The present disclosure is then further illustrated in details in combination with drawings and specific embodiments as follows.

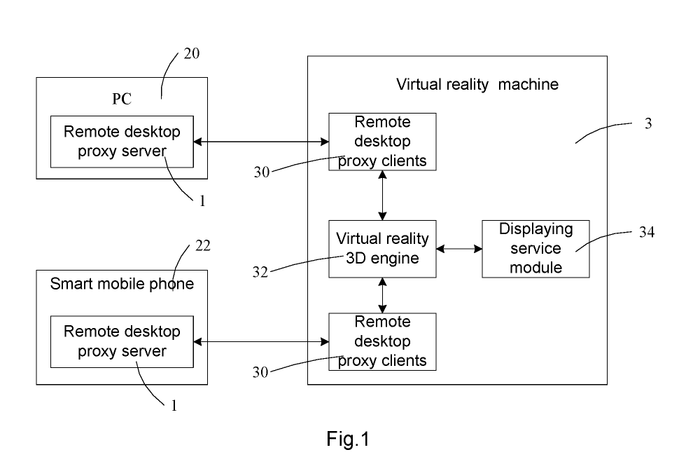

As shown in FIG. 1, the present disclosure provides a multi-interface unified displaying system based on virtual reality, which includes:

a plurality of remote desktop proxy servers 1, respectively built in a corresponding plurality of intelligent electronic devices to obtain corresponding current screen images of the intelligent electronic devices and transmit the screen images to the outside; and

a virtual reality machine (a VR machine) 3, which further includes:

a plurality of remote desktop proxy clients 30, correspondingly connected to the remote desktop proxy servers one by one to obtain the corresponding current screen images of the intelligent electronic devices;

a virtual reality 3D engine 32, configured to convert images transmitted from different remote desktop proxy clients 30 into a map that is identifiable by an image rendering program, then bind the map to a surface of a corresponding window in a virtual scene, further respectively render images corresponding to a left eye and a right eye into a pair of established buffer areas via an application programming interface of the image rendering program, and perform an anti-distortion processing with respect to contents in the buffer areas; and

a displaying service module 34, configured to display the images processed in the buffer areas.

The intelligent electronic device available for the present disclosure may be at least one of a personal computer (named as PC for short) and a smart phone, and in the embodiments as shown in FIG. 1, a personal computer (PC) 20 and a smart mobile phone 22 are simultaneously adopted. It can be understood that, the intelligent electronic device that may establish a connection with the virtual reality machine 3 may be of multiple numbers, for example, three, four, or more, not limited to two numbers as shown in FIG. 1.

The virtual reality machine is preferably a virtual reality helmet.

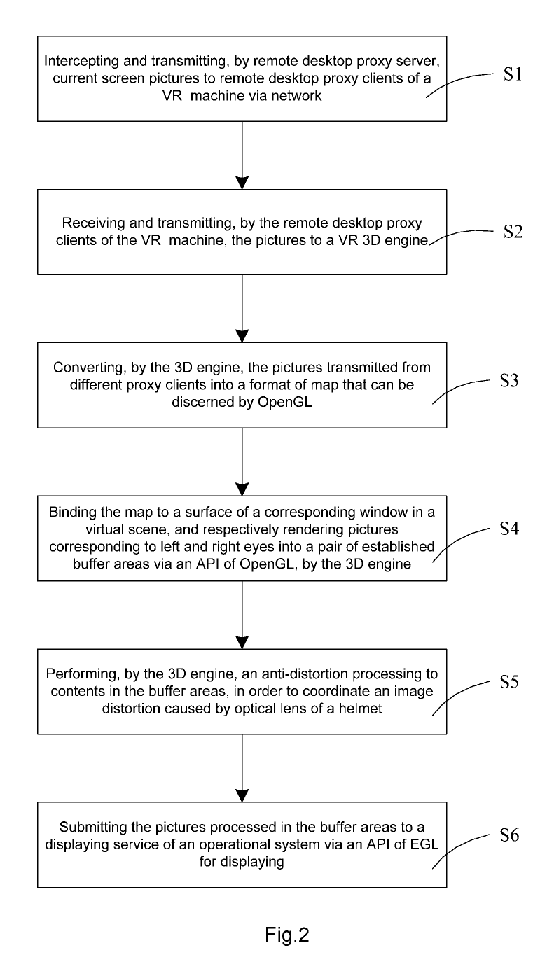

As shown in FIG. 2, the present disclosure further provides a multi-interface unified displaying method based on virtual reality, including the following steps.

Step S1: remote desktop proxy servers intercept current screen images and transmit the current screen images to remote desktop proxy clients of a VR machine via network.

Step S2: the remote desktop proxy clients of the VR machine receive the images and transmit the images to a VR 3D engine.

Step S3: the 3D engine converts the images transmitted from different proxy clients into a map format that is identifiable by an image rendering program.

Step S4: the 3D engine binds the map to a surface of a corresponding window in a virtual scene, and respectively render images corresponding to a left eye and a right eye into a pair of established buffer areas via API (an application program interface) of the image rendering program. In the embodiments as shown in FIG. 2, OpenGL is preferably adopted as the image rendering program.

Step S5: the 3D engine performs an anti-distortion processing with respect to contents in the buffer areas to coordinate an image distortion caused by optical lens of a helmet.

Step S6: the images processed in the buffer areas are submitted to a displaying service module for displaying via the API of EGL.

With the above multi-interface unified displaying method based on virtual reality, the present disclosure may further include the following step.

Step S7: a displacement control on a mouse pointer in displayed images is realized by the simulation of the virtual reality machine.

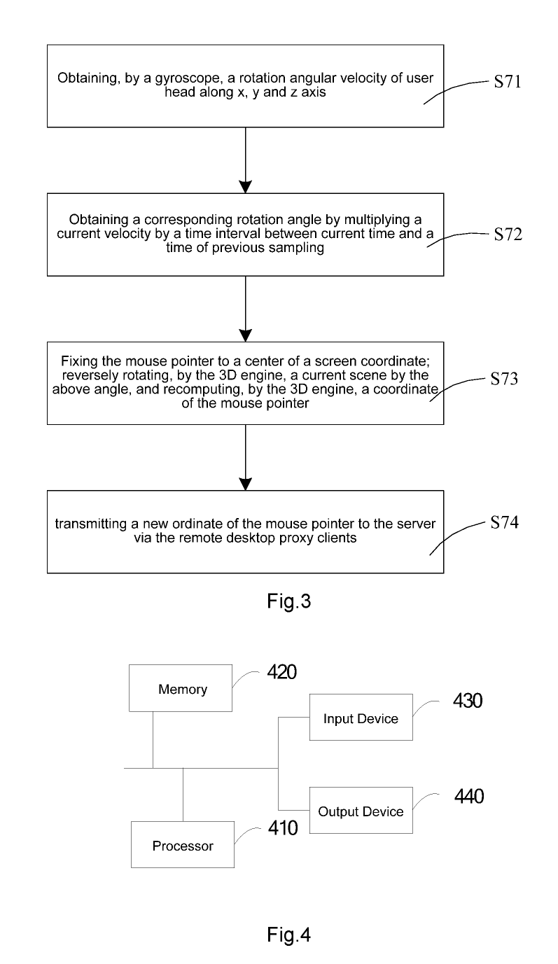

As shown in FIG. 3, the step S7 further specifically includes the following steps.

Step S71: a gyroscope of the virtual reality machine obtains rotation angular velocities of user head along x, y and z axis.

Step S72: a corresponding rotation angle is obtained by multiplying a current rotation angular velocity by a time interval between current time and a time of previous sampling.

Step S73: the mouse pointer is fixed to a center of a screen coordinate; and the 3D engine reversely rotates a current scene by the above angle and recalculates coordinate of the mouse pointer.

Step S74: the new coordinate of the mouse pointer is transmitted to the server via the remote desktop proxy client.

When performing the step S72, a data fusion algorithm may be further adopted to obtain the corresponding rotation angle.

According to the present disclosure, by simulating a function of 360×180 degree all-direction vision with a VR machine, corresponding current screen images on intelligent electronic devices are obtained by correspondingly connecting a plurality of remote desktop proxy clients 30 to remote desktop proxy servers built in the corresponding intelligent electronic devices one by one, and are intensively presented in a virtual reality scene after being processed by a 3D engine 32. Thus, a user may conveniently view user interfaces of a plurality of intelligent electronic devices simultaneously in a single interface such as the virtual reality scene. Furthermore, a simple operation on intelligent electronic devices, for example, a displacement control on a mouse pointer, may be realized by a control function of the virtual reality machine.

The embodiments of the present disclosure further provide a nonvolatile computer storage media, which stores computer-executable instructions for executing the steps S2-S7 of the multi-interface unified displaying method based on virtual reality aforementioned.

FIG. 4 is a hardware structure diagram of the electronic device for executing the multi-interface unified displaying method based on virtual reality provided by embodiments of the present disclosure. Referring to FIG. 4, the device includes: one or more processors 410 and a memory 420. In FIG. 4, only one processor 410 is shown as an example.

The device for executing the multi-interface unified displaying method based on virtual reality may further include: an input device 430 and an output device 440.

The processor 410, the memory 420, the input device 430 and the output device 440 may be connected by bus or other means. FIG. 4 shows the devices are connected by bus as an example.

The memory 420 is a nonvolatile computer-readable storage media, which may be used to store nonvolatile software program, nonvolatile computer-executable program and module, such as the program instruction/module corresponding to the multi-interface unified displaying method based on virtual reality of the embodiments of the present disclosure. The processor 410 may perform various functions and applications of the server and process data by running the nonvolatile software program, instruction and module stored in the memory 420, so as to realize the steps S2-S7 of the multi-interface unified displaying method based on virtual reality aforementioned.

The memory 420 may include a program storage area and a data storage area, wherein the program storage area may store an operation system and an application program for achieving at least one function; the data storage area may store data established according to the use of the multi-interface unified displaying device based on virtual reality. In addition, the memory 420 may include a high-speed random access memory, and may further include a nonvolatile memory, such as at least one magnetic disk memory, flash memory or other nonvolatile solid state memory. In some examples, the memory 420 may preferably include memories set remotely with respect to the processor 410, wherein these remote memories may be connected to the multi-interface unified displaying device based on virtual reality via the network. The examples of the network include but are not limited to internet, intranet, local area network (LAN), mobile communication network and their combinations.

The input device 430 may receive the information of a number or a character as inputted, and generate key input signals relating to the user setting and function control of the multi-interface unified displaying device based on virtual reality. The output device 440 may include a display device such as a display screen.

The one or more modules are stored in the memory 420. When the one or more modules are executed by one or more processors 410, the multi-interface unified displaying method based on virtual reality according to any of the above embodiments are executed.

The above product may execute the method provided by the embodiments of the present disclosure, and has the corresponding functional module for executing the method, and therefore has beneficial effect. For the details that are not fully described in this embodiment, please refer to the methods provided by the embodiments of the present disclosure.

The electronic device of the embodiments of the present disclosure may be embodied in various forms, which include but are not limited to the following device.

(1) Mobile communication device, which is characterized by the mobile communication function, and the main objective of which is to provide voice communication and data communication. This kind of terminal includes: smart phone (e.g. iPhone), multimedia phone, feature phone and low-level phone etc.

(2) Ultra mobile personal computer device, which belongs to the range of personal computer, has the function of computing and processing and generally can also be used in mobile internet. This kind of terminal includes: PDA, MID and UMPC device etc., such as iPad.

(3) Portable entertainment device, which may display and play multimedia contents. This kind of device includes: audio and/or video player (e.g. iPod), hand-held game machine, electronic book device, smart toy and portable vehicle navigation device.

(4) Server, which is a device that provides computing service. The configuration of the server includes processor, hard disk, memory and system bus etc. The architecture of a server is similar to that of a general computer. However, the sever has a higher demanding with respect to the processing ability, stability, reliability, safety, expansibility and manageability etc, because the server is required to provide more reliable service.

(5) Other electronic device having function of data interaction.

The embodiments of the device have been described above for illustrative purposes only, wherein the units described as separated members may or may not be separated physically. The members shown as units may or may not be physical unit, that is, they may be located at one place, or may be distributed to a number of units in a network. The objective of the embodiments of the present disclosure may be achieved by selecting a part or all of the modules according to actual demand.

From the description of the above embodiments, the person skilled in the art may understand clearly that respective embodiments may be implemented by software in combination with a hardware platform, or by hardware only. Based on this understanding, the nature or the part contributory to the prior art of the technical solution as described above may be embodied in the form a computer software product, which may be stored in a computer-readable storage media, such as ROM/RAM, magnetic disk, optical disk etc., and may include a number of instructions for making a computer device (which may be a personal computer, a server or a network device etc.) execute the method according to the respective embodiments or a part of an embodiment.

It should be noted that the embodiments as described above are only for the purpose of illustrating the solution of the present disclosure, without limiting the scope thereof. Although the present disclosure have been described according to the previous examples, the person skilled in the art will appreciate that various modifications to the solution recorded in the respective examples and equivalent substitutions for part of the features are possible, without departing from the scope and spirit of the present application as defined in the accompanying claims.

What is claimed is:

1. A multi-interface unified displaying system based on virtual reality, comprising:
a plurality of remote desktop proxy servers, respectively built in a corresponding plurality of intelligent electronic devices to obtain corresponding current screen images of the intelligent electronic devices and transmit the screen images to the outside; and
a virtual reality machine, which further comprises:
a plurality of remote desktop proxy clients correspondingly connected to the remote desktop proxy servers one by one to obtain the corresponding current screen images of the intelligent electronic devices;
a virtual reality 3D engine, configured to convert the current screen images of the intelligent electronic devices transmitted from different remote desktop proxy clients into a map that is identifiable by a graphics programming interface, then bind the map to a surface of a corresponding window in a virtual scene, further respectively render images corresponding to a left eye and a right eye into a pair of established buffer areas via the graphics programming interface, and perform an anti-distortion processing with respect to contents in the buffer areas; and
a displaying service module, configured to display the images processed in the buffer areas.

2. The multi-interface unified displaying system based on virtual reality according to claim 1, wherein, the intelligent electronic device is at least one of a personal computer and a smart phone.

3. The multi-interface unified displaying system based on virtual reality according to claim 1, wherein, the virtual reality machine is a virtual reality helmet.

4. A multi-interface unified displaying method based on virtual reality, comprising:
intercepting current screen images by remote desktop proxy servers, and transmitting the current screen images to remote desktop proxy clients of a VR machine via network;
receiving the current screen images of intelligent electronic devices by the remote desktop proxy clients of the VR machine, and transmitting the current screen images of intelligent electronic devices to a VR 3D engine;
converting, by the 3D engine, the current screen images of the intelligent electronic devices transmitted from different proxy clients into a map format that is identifiable by a graphics programming interface;
binding the map to a surface of a corresponding window in a virtual scene by the 3D engine, and respectively rendering images corresponding to a left eye and a right eye into a pair of established buffer areas via the graphics programming interface;
performing, by the 3D engine, an anti-distortion processing to contents in the buffer areas, in order to coordinate an image distortion caused by optical lens of a helmet; and
submitting the images processed in the buffer areas to a displaying service module for displaying.

5. The multi-interface unified displaying method based on virtual reality according to claim 4, wherein, the graphics programming interface is OpenGL.

6. The multi-interface unified displaying method based on virtual reality according to claim 4, wherein, the method further comprising:
performing a displacement control on a mouse pointer in displayed images by the simulation of the virtual reality machine.

7. The multi-interface unified displaying method based on virtual reality according to claim 6, wherein, the step of performing a displacement control on a mouse pointer in displayed images by the simulation of the virtual reality machine further comprises:
obtaining, by a gyroscope of the virtual reality machine, rotation angular velocities of user head along x, y and z axis;
obtaining a corresponding rotation angle by calculating according to a current rotation angular velocity and a time interval between current time and a time of previous sampling;
fixing the mouse pointer to a center of a screen coordinate, reversely rotating, by the 3D engine, a current scene by the above angle, and recalculating a coordinate of the mouse pointer; and
transmitting the new coordinate of the mouse pointer to the servers via the remote desktop proxy clients.

8. The multi-interface unified displaying method based on virtual reality according to claim 7, wherein, in the step of obtaining a corresponding rotation angle by calculating according to a current rotation angular velocity and a time interval between current time and a time of previous sampling, a data fusion algorithm is adopted for calculating to obtain the corresponding rotation angle.

9. The multi-interface unified displaying method based on virtual reality according to claim 4, wherein, in the step of submitting the images processed in the buffer areas to a displaying service module for displaying, the images processed in the buffer areas are submitted to the displaying service module via an application programming interface of EGL.
